(19) United States
(12) Patent Application Publication
(10) Pub. No.: US 2026/0038355 A1
(43) Pub. Date: Feb. 5, 2026

(54) KNOCK DETECTION USING A DOORBELL CAMERA

(71) Applicant: Vivint LLC, Provo, UT (US)

(72) Inventors: Rongbin Lanny Lin, Provo, UT (US); Justin Tran, Provo, UT (US); Christopher Hall, Provo, UT (US); Erik Swenson, Provo, UT (US); Conner Mickelson, Provo, UT (US); Nathan Maus, Provo, UT (US)

(73) Assignee: Vivint LLC, Provo, UT (US)

(21) Appl. No.: 19/289,272

(22) Filed: Aug. 4, 2025

Related U.S. Application Data
(60) Provisional application No. 63/678,618, filed on Aug. 2, 2024.

(51) Int. Cl. G08B 21/22; G01H 1/00; G06V 40/10; G06V 40/20; H04N 7/18

(52) U.S. Cl. CPC G08B 21/22; G01H 1/00; G06V 40/10; G06V 40/20; H04N 7/186

(57) ABSTRACT

Presented herein are systems and methods for a camera that can detect a knock. A system can include a doorbell housing. The doorbell housing can include a camera, microphone, and processor. The camera can capture video data of a detection zone in front of a door. The microphone can receive audio. The processor can be a processor coupled to the camera and microphone. The processor can detect a knock in the audio and generate a notification to transmit to a homeowner. The processor can activate the microphone upon detecting a person within the detection zone using the camera. The microphone can capture audio within the detection zone.

### CROSS REFERENCE TO RELATED APPLICATION

This application is a claims priority to U.S. Patent Application Ser. No. 63/678,618, filed Aug. 2, 2024, the entire contents of which are hereby incorporated by reference as though fully set forth herein.

### TECHNICAL FIELD

This application generally relates to systems and methods for detecting and analyzing environmental sounds and visual cues to enhance notification and monitoring capabilities.

### BACKGROUND

In home security and communication, doorbell cameras often rely on visual cues to notify homeowners of a visitor's presence. Traditional doorbell cameras overlook sound-based detection mechanisms. Traditional doorbell cameras can have shortcomings in detecting persons such as when a visitor may not directly interact with the doorbell but nonetheless signifies their presence through other means, such as knocking. Traditional doorbell cameras also encounter issues with latency and privacy. Furthermore, differentiating between types of visitor interactions poses a challenge. There is a need for a solution that combines audio and visual signals for prompt and accurate detection, enhancing responsiveness and privacy through local processing.

### SUMMARY

The present disclosure provides a system for enhancing doorbell camera functionality through the integration of both audio and visual detection capabilities to accurately identify and notify homeowners of visitor interactions, such as knocking, without direct engagement with the doorbell. The system can employ a combination of sound recognition and object detection algorithms to process interactions locally on the device, thereby reducing latency and preserving privacy. By analyzing audio samples with visual cues within a defined detection zone, the system can notify a homeowner when a visitor is present, irrespective of the visitor's physical interaction with the doorbell. This innovative approach addresses the limitations of current doorbell cameras by offering a more comprehensive and responsive solution to home security and visitor monitoring.

The system can include a doorbell housing, which can include a camera, microphone, and processor. The camera can capture video of a detection zone in front of a door. The microphone can receive audio data. The processor can detect a knock in the audio data and generate a notification to transmit to a homeowner. The processor can be coupled to the camera and the microphone. The processor can activate the microphone to receive the audio data upon detecting a person within the detection zone using the camera. The microphone can capture audio data within the detection zone.

### BRIEF DESCRIPTION OF THE DRAWINGS

The accompanying drawings constitute a part of this specification, illustrate an embodiment, and, together with the specification, explain the subject matter of the disclosure.

FIG. 1 is a block diagram of a system, according to an embodiment.

FIG. 2 illustrates an example of a camera, according to an embodiment.

FIG. 3 is a flow diagram of a method for a camera that can detect a knock, according to an embodiment.

### DETAILED DESCRIPTION

Disclosed herein are systems and methods for a camera that can detect a knock. Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

As described herein, a smart detection system, particularly a doorbell camera apparatus, can be designed to enhance the security and convenience of monitoring entryways to a building or residence. The system may comprise a doorbell camera that can include an image sensor, a microphone, and a processor integrated with an Artificial Intelligence (AI) model. The camera can capture visual data within a detection zone, while the microphone is attuned to recognize audio cues such as knocks. The processor can arrange the functionality of the camera and microphone, leveraging the AI model to distinguish between common ambient noises and the distinct sound of someone knocking on the door. Upon successful detection of a knock, the system is configured to send a notification to the homeowner, which may be accessed on various user interfaces such as mobile phones, tablets, or other smart devices. This can provide the homeowner with immediate awareness and the ability to respond to visitors promptly. The system can integrate security, user preference adaptability, and advanced monitoring technology to create a responsive and intuitive home entry management solution.

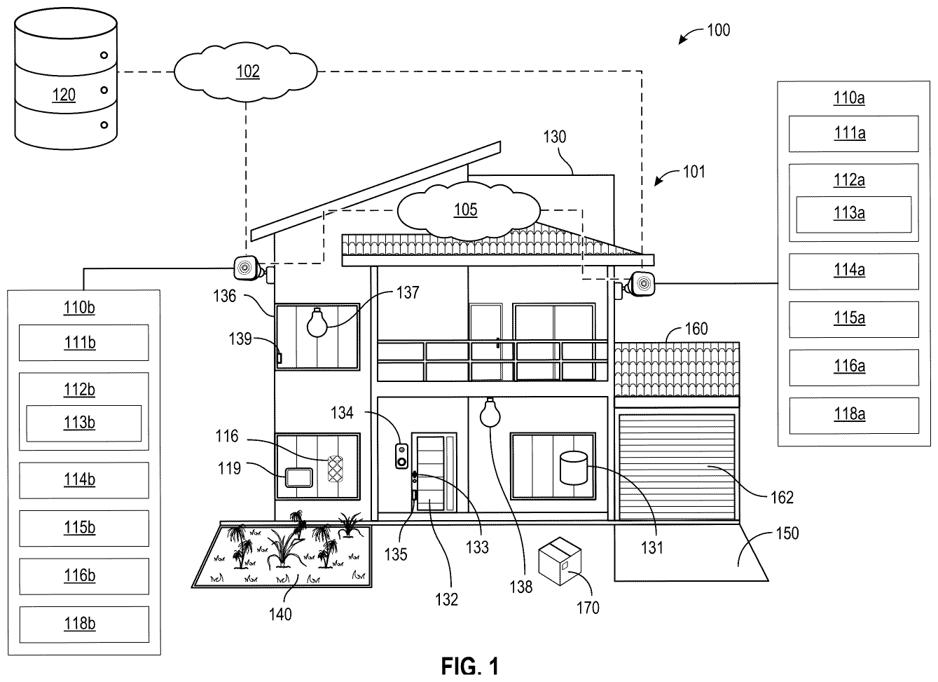

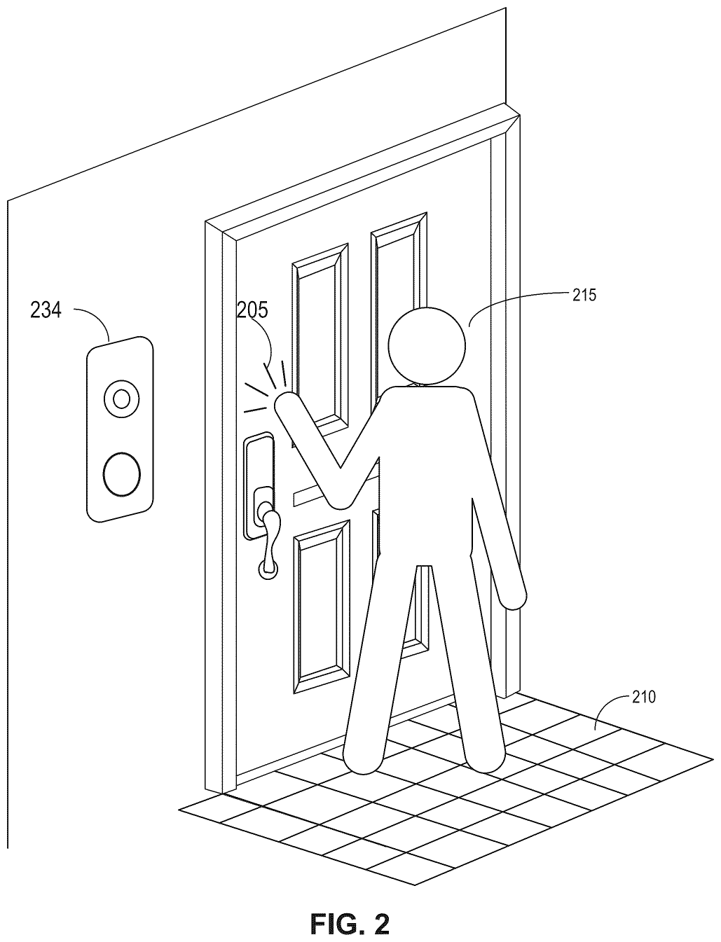

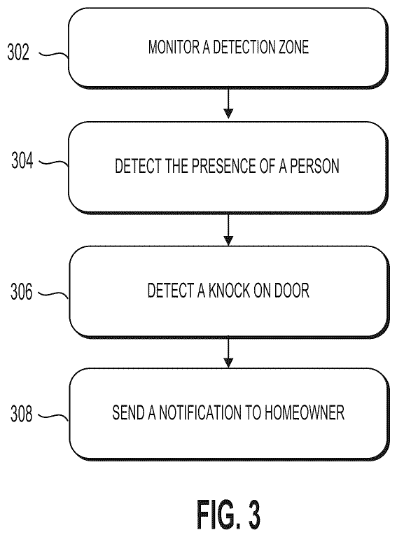

Though various configurations may be utilized to employ these embodiments, the description below shows an example environment of a building in FIG. 1, an example of a camera in FIG. 2, and a method of a camera that can detect a knock in FIG. 3.

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a depth sensor 114a (e.g., radar sensor 114a), a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect occupancy. For example, the microphones 118 may be configured to sense sounds, such as voices, broken glass, door knocking, or otherwise, and an audio processing system may be configured to process the audio so as to determine whether the captured audio signals are indicative of the presence of a person in the environment 100 or structure 130.

A user interface 119 may be installed or otherwise located at the building 130. The user interface 119 may be part of or executed by a device, such as a mobile phone, a tablet, a laptop, wall panel, or other device. The user interface 119 may connect to the cameras 110 and/or doorbell camera 134 via the network 102 or the local network 105. The user interface 119 may allow a user to access sensor data of the cameras 110 and/or doorbell camera 134. In an example, the user interface 119 may allow the user to view a field of view of the image sensors 115 and hear audio data from the microphones 118. In an example, the user interface may allow the user to view a representation, such as a point cloud, of radar data from the radar sensors 114. The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

In some implementations, the cameras 110 may monitor one or more objects based on a combination of data and/or determinations from the multiple sensors (e.g., the cameras 110 or microphones).

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 102, lighting a fireplace, powering an electrical outlet, turning on or play a predefined channel or video or music on a television or other device, starting or stopping a kitchen appliance, starting or stopping a sprinkler system, opening or closing a garage door 103, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The security system 101 and/or the one or more security devices, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101 and/or the one or more security devices are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g., stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

FIG. 2 depicts doorbell camera 234 that can detect a knock 205, such as a person knocking on a door. The knock 205 can be referred to as door knock 205, though the knock can be performed on a wall, window, or other surface besides a door. The doorbell camera 234 can be positioned in an outdoor environment (e.g., front door, garage door, garden, backyard, etc.) or an indoor environment (e.g., office door, apartment door) to monitor an area (e.g., detection zone 210).

The doorbell camera 234 can be the camera 110 described in FIG. 1. The doorbell camera 234 can perform the functionality of the camera 110, and/or the doorbell camera 234 can include the components and/or features of the camera 110 (e.g., camera 110a features). The doorbell camera 234 can include the image sensor 115, processor 111, memory 112, depth sensor 114 (e.g., radar sensor 114), speaker 116, AI model 113, and microphone 118. The doorbell camera 234 can be connected to the local network 105 and/or the network 102 and can communicate with other smart devices within the environment 100.

In some embodiments, the doorbell camera 234 can be configured to correlate and/or analyze data from multiple sensors together. For example, doorbell camera 234 may detect a person 215 or other object in a specific area (e.g., detection zone 210) and/or field of view of the image sensors 115 and may confirm a presence of the person 215 or other object using data from additional sensors of the cameras 110 such as the radar sensors 114 and/or the microphones 118, confirming a sound made by the person 215 or other object, a distance and/or speed of the person or other object, or the like. The doorbell camera 234, via the AI model 113, can identify the presence of a person 215. The doorbell camera 234, via the visual/image data (e.g., from image sensor 115) and the AI model 113, can categorize and/or classify that the person 215 is approaching the door with the intent to visit, passing by within close proximity to the doorway, and/or engaging in other activities such as delivery package placement.

The detection zone 210 can be the area within the doorbell camera 234 field of view where motion and sound analytics can be actively employed. The detection zone 210 can be a virtual boundary designed to focus the doorbell camera 234 sensors. The detection zone 210 can include the doorstep or walkway leading to the door. The detection zone 210 can include areas where visitor interactions are most likely to occur. The detection zone 210 can minimize unnecessary notifications from activity outside the set perimeter.

The AI model 113 can include more than one AI models 113, which may be stored on the doorbell camera 234 and executed by the processor 111, though alternative embodiments may include AI models stored and/or executed in a cloud environment or on a hub or panel of the system. The AI model 113 can be exposed and pre-trained to a dataset of human images and videos. The AI model 113 can learn and recognize human features and characteristics. The AI model 113 can be periodically or continuously trained through feedback loops. The doorbell camera 134, via the AI model 113, can identify process and manage data collected from its sensors in real-time. The doorbell camera 134 can analyze video data to detect motion or recognize familiar faces and can interpret depth data to assess the distance of objects or individuals from the doorbell camera 134.

The AI model 113 can be exposed and pre-trained to a dataset of knock 205 sounds, images, and videos. The AI model 113 can learn to detect door knock 205 sounds and/or other knock 205 sounds (e.g., knock on wall, window, etc.). The AI model 113 can differentiate between door knock 205 sounds and other sounds that may be similar to door knock 205 sounds but are not door knock 205 sounds. The AI model 113 can be trained to distinguish door knock 205 sounds from other ambient or incidental sounds. The AI model 113 can recognize the acoustic pattern of door knock 205 sounds, which can allow the doorbell camera 134 to accurately detect actual door knocking events. The training can teach the AI model 113 to differentiate between various door knock 205 sounds, which can range in intensity, rhythm, and patterns. The AI model 113 can be periodically or continuously trained through feedback loops.

The AI model 113 can be trained to analyze and/or distinguish door knocks on various materials, including wood, steel, glass, and other materials used in residential and commercial entryways. This distinction can be useful because different materials can have different acoustic signatures when knocked upon. The AI model 113 training dataset can include a range of knocking sounds on various surfaces to ensure knock 205 detection on different material types and surfaces.

The AI model 113 can be trained on a corpus of images and videos that depict the act of door knocking in different contexts. The image and video data training can enable the AI model 113 to identify the motion associated with door knocking and can provide a complementary verification method to the acoustic analysis and/or detection. The AI model 113 can use image and video data to correlate the type of knock 205 with the door material. Alternatively, the AI model 113 can be trained on audio data and recognize patterns and signals of a door knock based on the sound of the knock without using images and/or video.

FIG. 3 illustrates a flow diagram of an example method for detecting a knock. The method 300 may be implemented using any one or more of the components and devices detailed herein in conjunction with FIGS. 1-2. In overview, the method 300 may be performed by the doorbell camera 134, via visual/image data (e.g., from image sensor 115) and AI model 113. Additional, fewer, or different operations may be performed in the method 300 depending on the embodiment. At least one aspect of the operations is directed to a system, method, apparatus, or a computer-readable medium.

At step 302, the method can include monitoring monitor an area (e.g., detection zone 210) using the doorbell camera 134. The doorbell camera 134 can capture audio and visual data that represent environmental and human-related cues. This step may include real-time or periodic analysis of the detection zone 210 to detect changes that could indicate the presence of a person 215, such as movement, light variations, or sound.

At step 304, the doorbell camera 134, via the processor 111 and AI model 113, can detect the presence of a person 215 in the detection zone 210. The detection of the person may utilize artificial intelligence and machine learning models to interpret the audio and visual data, distinguishing between human and non-human presence, and distinguishing between the person 215 is approaching the door with the intent to visit, passing by within close proximity to the doorway, and/or engaging in other activities such as delivery package placement. The AI model 113 can differentiate between human and non-human activity based on audio data or video data.

A sound profile can include a variety of sound signatures associated with human presence, such as voices or footsteps. By matching the detected sounds to the sound profile, the AI model 113 can differentiate between human and non-human activity and detect the person 215. The AI model 113 can adapt over time, learning from new sounds and adjusting the sound profile to enhance the AI model 113 predictive accuracy.

At step 306, the method can include detecting a knock. The knock 205 can be on a door, window, wall, etc. The doorbell camera 134 acoustic sensing capabilities can detect the knock has occurred. The doorbell camera 134 microphone 118 can be activated upon the detection/presence of a person 215 to listen for the distinct sound patterns of a knock. The doorbell camera 134 can detect knocks 205 on various materials, including wood, steel, glass, and other materials used in residential and commercial entryways.

At step 308, upon detecting a person 215 and a knock 205, the method can include sending a notification to a homeowner. When detecting a person 215 and a knock 205, the doorbell camera 134 can create a notification that includes relevant data such as time, visual confirmation, and/or the video clip of the knock 205. The notification can be sent from the doorbell camera 134 to the homeowner user interface 119 to ensure that homeowners are informed of the activity at their door in real time. The notification can be sent from the doorbell camera 134 to the homeowner smartphones, tablets, computers, or any smart device that is part of the home network and capable of receiving such notifications. The notification is typically delivered through a secure and encrypted channel within local network 105 and/or the network 102, ensuring that the homeowner can be informed of the situation at their doorstep, regardless of their physical location. This can allow for immediate viewing of the event, real-time interaction with the visitor, or other responsive actions as deemed necessary by the homeowner.

The notification may be based on predefined user preferences, historical data patterns, or real-time occupancy information.

The notification/notification message can be customized to the specifications of the homeowner. The notification message can range from simple alerts to detailed reports, taking into account the homeowner response to previous notifications and their indicated level of sensitivity to different types of events. For example, if the homeowner prefers to be notified only when a person lingers for an extended period in the detection zone, or if repeated knocks are detected within a certain timeframe, the doorbell camera 134 can adapt its notification criteria accordingly. The AI model 113 can analyze historical interaction data to identify and learn the homeowner habitual response patterns, refining the notification process over time. This results in a tailored alert system that evolves to match the homeowner's lifestyle and security preferences, thereby enhancing the overall efficiency and user experience of the doorbell camera 134 system.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system, comprising:
a doorbell housing comprising:
a camera configured to capture video data of a detection zone in front of a door;
a microphone configured to receive audio data;
a processor coupled to the camera and microphone, the processor configured to:
detect a knock in the audio data; and
generate a notification to transmit to a homeowner.

2. The system of claim 1, wherein the processor is configured to activate the microphone to receive the audio data upon detecting a person within the detection zone using the camera.

3. The system of claim 1, wherein the microphone is configured to capture the audio data within the detection zone.

4. The system of claim 1, wherein processor is further configured to analyze the video data to identify movement in the detection zone.

5. The system of claim 1, wherein the processor executes instructions corresponding to a model trained on at least one of audio or visual data.

6. The system of claim 1, wherein the processor is configured to distinguish between human and non-human presence in the detection zone based on at least one of the audio data or video data.

7. The system of claim 1, wherein the notification facilitates interaction of the homeowner to the detection zone.

8. A method, comprising:
capturing video data from a detection zone in front of a door;
capturing audio data from in front of the door;
detecting a knock based on the audio data; and
generating a notification based on the detected knock; and
transmitting the notification to a homeowner indicative of the knock.

9. The method of claim 8, further comprising activating a microphone to capture the audio data upon detection of a person based on the video data.

10. The method of claim 8, wherein the audio data is captured by a microphone of a doorbell positioned exterior to a front door.

11. The method of claim 8, further comprising analyzing the video data to identify movement in the detection zone.

12. The method of claim 8, further comprising training a model for knock detection based on at least one of historical audio or visual data.

13. The method of claim 8, further comprising distinguish between human and non-human presence in the detection zone based on at least one of the audio data or video data.

14. The method of claim 8, wherein the notification facilitates interaction of the homeowner to the detection zone.

15. A system of providing notifications to a user of an alarm system, the system comprising:
a non-transitory memory;
an input/output (I/O) unit;
one or more processors in communication with the memory and I/O unit, the one or more processors being configured to:
capture video data from a detection zone in front of a door;
capture audio data from in front of the door;
detect a knock based on the audio data; and
generate a notification based on the detected knock; and
transmit the notification to a homeowner indicative of the knock.

16. The system of claim 15, wherein the processor is further configured to activate a microphone to capture the audio data upon detection of a person based on the video data.

17. The system of claim 15, wherein the audio data is captured by a microphone of a doorbell positioned exterior to a front door.

18. The system of claim 15, wherein the processor is further configured to analyze the video data to identify movement in the detection zone.

19. The system of claim 15, wherein the processor is further configured to train a model for knock detection based on at least one of historical audio or visual data.

20. The system of claim 15, wherein the processor is further configured to distinguish between human and non-human presence in the detection zone based on at least one of the audio data or video data.
